(19) United States
(12) Patent Application Publication
(10) Pub. No.: US 2015/0058095 A1
(43) Pub. Date: Feb. 26, 2015

(54) Method and System for Measuring and Improving Marketing Capability

(71) Applicant: Acxiom Corporation, Little Rock, AR (US)

(72) Inventors: William Clay, Conway, AR (US); Kristen Mougeot, Little Rock, AR (US); Brently Barrow, Little Rock, AR (US); Bridget Farris, Little Rock, AR (US); Steve Manatt, Little Rock, AR (US); Jim Rock, Chicago, IL (US)

(21) Appl. No.: 14/338,172

(22) Filed: Jul. 22, 2014

Related U.S. Application Data
(60) Provisional application No. 61/869,797, filed on Aug. 26, 2013.

(51) Int. Cl. G06Q 10/06

(52) U.S. Cl. CPC G06Q 10/06395
USPC 705/7.41

(57) ABSTRACT

A computerized method and system for assessing and improving the capability of a marketing organization creates output that allows for quick visualization of gaps in marketing organization maturity. Binary questions are employed to ensure inter-coder reliability for the assessment. A marketing maturity quotient (MMQ) may be generated to provide feedback on maturity along a standardized scale. A dynamic, normalized database is used in conjunction with a body of knowledge (BOK) to provide a comparison between MMQ results for an organization and those of the average and leader MMQs. A product catalog database is used to provide suggested improvements matched to particular gaps in a marketing organization.

### CROSS-REFERENCE TO RELATED APPLICATIONS

This application claims the benefit of U.S. provisional patent application No. 61/869,797, filed on Aug. 26, 2013, and entitled “Marketing Maturity Model.” Such application is incorporated herein by reference in its entirety.

### STATEMENT REGARDING FEDERALLY SPONSORED RESEARCH OR DEVELOPMENT

Not applicable.

### BACKGROUND OF THE INVENTION

The present invention relates to computerized methods and systems for measuring and improving marketing maturity, and in particular to a computerized system and method for capability maturity assessments for marketing organizations.

A capability maturity model (CMM) is a model developed to measure the degree of formality and optimization of processes through the study of data gathered from the organization engaging in those processes. The term “organization,” as used herein, may include any type of business group or entity as well as various departments, teams, or other subsets of a business group or entity. The goal of a CMM is to objectively assess the capability or “maturity” of an organization. The first CMMs were developed at Carnegie Mellon University beginning in the 1980's for the purpose of evaluating the capability of software contractors working for the U.S. Department of Defense. An underlying insight upon which CMMs are based is that organizations mature their processes in successive stages, based on solving process problems in a specific order. Although CMMs were first developed and used to measure software development processes, they have since been applied to other fields, such as information technology (IT) service management processes. In addition, CMM principles have been applied to human resources and management processes in the development of “people” CMMs. The successful deployment of CMMs in these various areas has led to significant improvement in the measured processes by identifying the level of maturity and further by identifying those steps required in order for an organization to advance to a greater level of capability in the areas measured.

Still today, the Capability Maturity Model Integration (CMMI) capability framework administered by Carnegie Mellon University is required by many Department of Defense and government programs for government contracts, especially software development. A “capability framework” is a specific type of analytical tool that provides a common structure to measure the current performance of capabilities, identify desired performance, determine the gaps between current and desired performance, and perform a series of diagnostic and analytical tests to establish priorities for capability improvement. There are many capability frameworks in use today, both public and private. Each capability framework has its own advantages and disadvantages, which determine its suitability for a specific application.

The operational, organizational, financial, and technological capabilities that are required for global marketing efforts consume large amounts of capital, on-going operating expense, and human resources. It is not uncommon for large companies with global marketing efforts to expend over one billion U.S. dollars annually in total marketing expenditures. Given the high cost, business plans that seek additional investment in marketing capability creation will need to be economically justified, with business plans and specific strategic initiatives proposed that will achieve measurable improvements in marketing capability maturity with associated business results.

Although CMMs have been used in industry to achieve business improvement goals for decades, attempts to use CMMs for marketing analysis have been limited in their utility. Reasons for the limited utility of these CMMs include: use of ranges in response to questions; reliance on self-reported data rather than objective, fact-based assessment; reliance on experts in order to assess; lack of an evidence-based approach; lack of a marketing focus; lack of data normalization; lack of a comparative base; lack of inter-coder reliability; and lack of predictability. CMMs have not been dynamic, thus restricting use. CMMs have also not been action oriented in failing to connect a solution or solutions to an assessment.

### BRIEF SUMMARY OF THE INVENTION

According to certain aspects of the subject matter described in this specification, a computerized method and system is presented for measuring and improving the capability of a marketing organization. A specific focus is marketing strategy and the data, business processes, technology, people and organizational design required to implement a marketing strategy. The computerized method and system leverages a custom software application incorporating a specific set of algorithms in order to create an objective, fact-based assessment, which is characterized by inter-coder reliability. In various embodiments, the invention may include multiple “points of entry” or access options to allow different types of users to receive value tailored to their particular business needs. These include, by way of example, client-assisted assessment; account teams performing the assessment; professional consultants performing the assessment on behalf of a client; tradeshow booths; and the website of a provider of the service, the website being generally accessible over the Internet. Parties making use of the invention through these points of entry may include, for example, senior executives of public and private corporations; account executives within a single company; account executives across regions in the same company; consulting professionals within a single company; and account executives within partner organizations working with a single company. In certain embodiments, the invention incorporates the build and maintenance of a dynamic normative database, which, among other things, is used to track trends by industry benchmarks over time. It may be seen that the present invention fills a specific gap in business management, namely, that of measuring and improving the business effectiveness of the specific operational, organizational, financial, and technological capabilities required for global marketing in today's complex, multi-channel marketing ecosystem.

In various examples of certain embodiments, the computerized method and system provides the following advantages not presently addressed by existing efforts to improve marketing organization performance: a pre-defined, well organized, comprehensive body of knowledge (BOK) for global, multi-channel, database marketing and advertising; capability gaps linked to a set of common marketing business challenges defined by the specific capability root causes of these challenges; capability gaps linked to prescriptive product and service remedies to enable the achievement of future targets; capability gaps algorithmically derived from current and target maturity scores; capability current state and target state scores, and gaps, stored in a normative database, where the data structure has been designed to allow performance benchmarks and best practices to be identified, while protecting the privacy and confidentiality of the subject companies' current and target scores, in order to achieve measured capability maturity improvements against stated business objectives, targets, and key performance indicators; the creation of one or more Marketing Maturity Quotients (MMQs)—comparative indexes allowing subject companies to objectively identify their specific marketing capability strengths and weaknesses on a scale, such as 0-100, that reflects the client's current level of “maturity” for a set of marketing capabilities (overall, capability, attribute, dimension, or business challenge) at a particular point in time and year over year; and use of the MMQs to benchmark the marketing capabilities of one company against that of peers, competitors, and others across industries and geographies in an objective manner, while protecting the identity of any subject company, and the confidentiality of any proprietary practices, methods, or tools that a company may use to enable its performance.

These and other features, objects and advantages of the present invention will become better understood from a consideration of the following detailed description of the various embodiments and appended claims in conjunction with the drawings as described following:

### BRIEF DESCRIPTION OF THE SEVERAL VIEWS OF THE DRAWINGS

FIG. 1 illustrates an overall architecture of an embodiment of the present invention.

FIG. 2A illustrates the comprehensive knowledge architecture for the marketing maturity model Body of Knowledge (BOK) according to an embodiment of the present invention.

FIG. 2B illustrates the marketing maturity model BOK organized into the CMMI framework according to a preferred embodiment of the present invention.

FIG. 2C is a data model diagram for a BOK according to an embodiment of the present invention.

FIG. 3 illustrates the integrated scoring approach for capability assessment according to an embodiment of the present invention.

FIG. 4A illustrates the assessment heat map produced based on data visualization templates according to an embodiment of the present invention.

FIG. 4B illustrates the capabilities sorted by gap report produced based on data visualization templates according to an embodiment of the present invention.

FIG. 4C illustrates the dimensions sorted by gap report produced based on data visualization templates according to an embodiment of the present invention.

FIG. 4D illustrates a consumer gap insights report produced based on data visualization templates according to an embodiment of the present invention.

FIG. 5 illustrates a marketing maturity meter displaying the overall MMQ for an individual company in comparison to average and leader MMQs.

FIG. 6 is a report comparing capability MMQs for an organization to average and leader MMQs.

FIG. 7 is a report showing dimension MMQs for a retail/specialty organization in comparison to averages and leaders in a spider chart format according to an embodiment of the present invention.

FIG. 8 is a flow chart showing a product/service recommendation method according to an embodiment of the present invention.

### DETAILED DESCRIPTION OF THE PREFERRED EMBODIMENT(S)

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

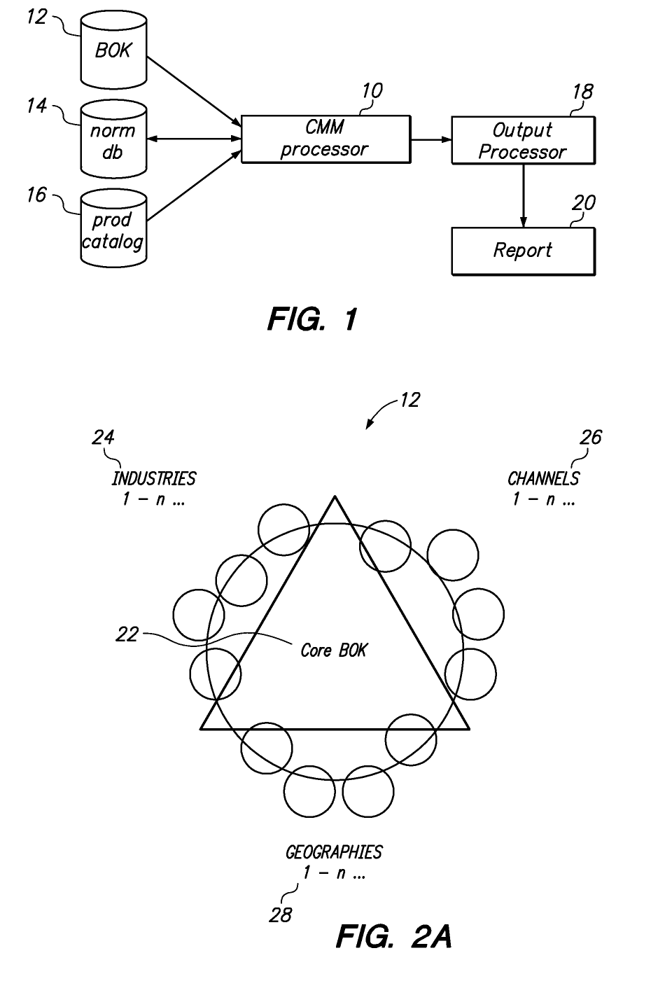

Referring now to FIG. 1, the basic architecture of an embodiment of the present invention may be described at a high level. CMM processor 10 is computing hardware that has been programmed with specialized software in order to provide the specific capability maturity model (CMM) functions as described herein. CMM processor 10 may use data drawn from a number of sources, including body of knowledge (BOK) 12, normative database 14, and product catalog 16, each of which will be more fully described below.

CMM processor 10 interacts with and provides output to output processor 18. Output processor 18 is preferably computing hardware that has been programmed with specialized software in order to provide processing related to the creation, management, and implementation of marketing strategies and tactics. In certain embodiments, output processor 18 may be the sales platform offered by Salesforce.com (SFDC), which includes a number of tools that facilitate sales team coordination, customer relationship management (CRM), customer prospecting, sales metrics tracking, and various customer targeting products and services. In other embodiments, output processor 18 may be implemented as services other than SFDC, or may be integrated with CMM processor 10, or output processor 18 may be absent. CMM processor 10 generates a number of reports 20, as more fully described below, through the platform of output processor 18.

The various components of the system as shown in FIG. 1 may be integrated or may be implemented as physically separate components, located proximately to each other or remote, such as in cloud-based computing. The various components may communicate with each other over a local bus, a local area network (LAN), a wide area network (WAN), or any other communications network, including without limitation the Internet.

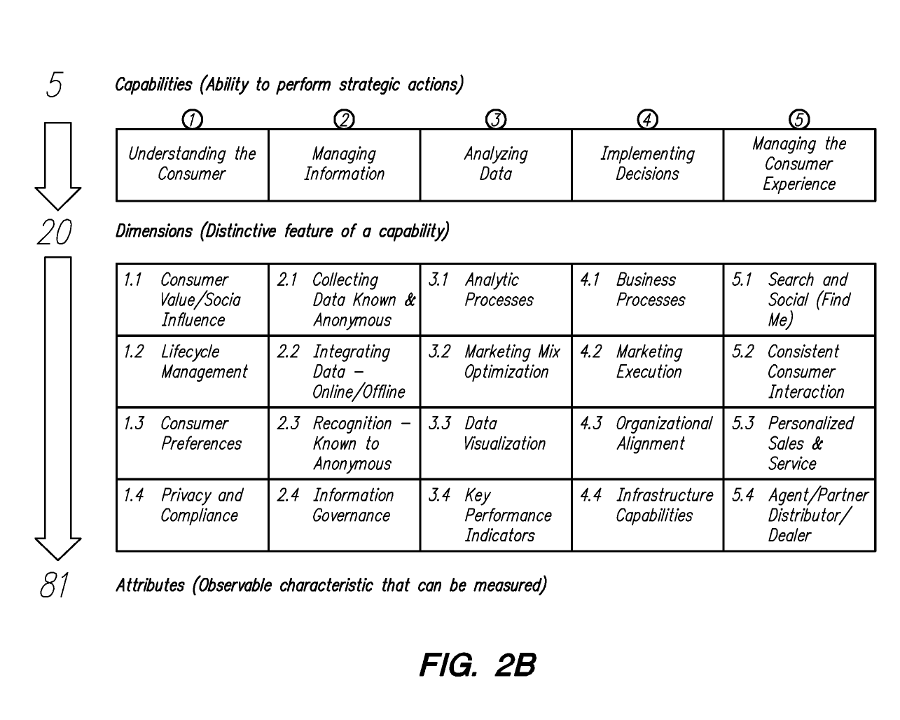

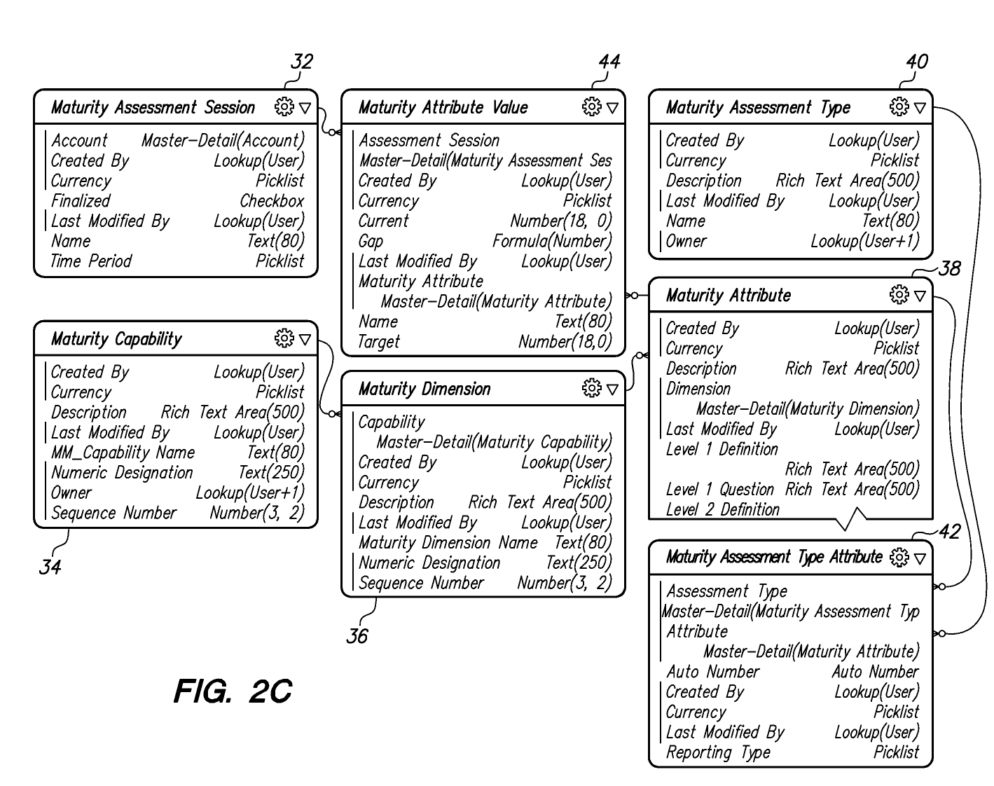

Referring now to FIG. 2A, a comprehensive knowledge architecture for the marketing maturity model BOK 12 may be described according to its general architecture. BOK 12 contains the strategic capabilities for an organization, with each capability being associated with multiple dimensions, and each dimension in turn being associated with multiple attributes. A “capability” is defined as the ability to perform a strategic action by the marketing organization. A “dimension” is defined as a distinctive feature of a capability. An “attribute” is defined as an observable characteristic that can be measured for a particular marketing dimension. At the center of BOK 12 is core set 22, which includes each of the capability, dimension and attribute definitions and questions that make up the business function of database marketing and advertising. Each is organized into a specific capability framework to enable the objective assessment of capabilities. Surrounding this core set 22 is a set of industry knowledge 24, channel knowledge 26, and geography knowledge 28 that makes up the operational, organizational, financial, and technological capabilities required for activation of multi-channel database marketing capabilities necessary to achieve business goals. In addition, core set 22 of BOK 12 may include one or more business challenges that are presented to a marketing organization. Business challenges are particular areas often identified as in need of improvement in various organizations or that marketing organizations routinely face, and which are matched to particular attributes. Taken together, this data makes up the comprehensive knowledge architecture for BOK 12. Industry knowledge 24 may be divided into business-to-consumer, such as retail, financial, and telecom as a few specific examples, and business-to-business. Channel knowledge 26 may include various marketing channels, such as direct mail, email, and television. Geography knowledge 28 may be referenced to various geographic regions divided for marketing purposes, such as North America, Latin America, Asia-Pacific, and Europe-Middle East-Africa.

FIG. 2B illustrates the BOK 12 of FIG. 2A organized into a CMMI framework display for a particular example. In this example, BOK 12 is organized into five separate capabilities: “Understanding the Consumer,” “Managing Information,” “Analyzing Data,” “Implementing Decisions,” and Managing the Consumer Experience.” These five capabilities represent core abilities that are called upon for a marketing organization in order to perform strategic marketing actions related to global, multi-channel, database marketing and advertising. Each of the capabilities is associated with multiple dimensions, in this case each capability having four dimensions. For example, for the capability “Understanding the Consumer,” the dimensions are “Consumer Value/Social Influence,” “Lifecycle Management,” “Consumer Preferences,” and “Privacy and Compliance.” Each of these dimensions represents a distinctive feature of the capability “Understanding the Consumer.” Likewise, each of these dimensions are associated with a number of attributes, in this case a total of 81 attributes being a part of BOK 12 and distributed among the 20 dimensions. Although a particular number of capabilities, dimensions, and attributes are shown and described in connection with this embodiment, the invention is not so limited, and certain embodiments may incorporate any number of capabilities, dimensions within capabilities, and attributes associated with each dimension. Likewise, although particular capabilities are illustrated, and certain dimensions and attributes are associated therewith, the invention is not so limited, and may include any other set of capabilities, dimensions, and attributes that may be included for the purposes of measuring and improving marketing capability for an organization.

FIG. 2C is a visualization of the data structure for certain embodiments of the present invention as that structure is implemented in BOK 12 normative database 14. For each capability maintained in BOK 12, there is a maturity capability record 34 that stores data relevant to that capability. The data includes its name, description, and a numeric designation. Linked to each maturity capability record 34 is a maturity dimension record 36 for each of the dimensions associated with that capability. The data stored in each maturity dimension record 36 includes the name, description, and a numeric designation for that dimension. Likewise, linked to each maturity dimension record 36 is a maturity attribute record 38 for each of the attributes associated with that capability. The data stored in each maturity attribute record 38 includes, in addition to the name/title, description, and numeric designation for the attribute, a series of questions and definitions associated with each question. The role of the questions and definitions will be explained further below.

A maturity assessment type record 40 is provided for each type of maturity assessment performed in certain embodiments. Associated with each maturity assessment type record 40 is a maturity assessment type attribute record 42, which contains data pertaining to each attribute associated with that maturity assessment type, and links that maturity assessment type to each of the associated maturity attributes through a link to the corresponding maturity attribute record 38.

Associated with each session of use of the maturity model according to certain embodiments, and preferably stored in normative database 14, is a maturity assessment session record 32, where data such as the name of the session and the dates when it was created, modified, and finalized are stored. Associated with each maturity assessment session record 32 is a plurality of maturity attribute value records 44, which track information related to a particular assessment session, such as the attribute value and associated gap (as further explained below) for that particular attribute for that assessment. Each maturity attribute value record 44 further links to the maturity attribute record 38 for that attribute.

Normative database 14 preferably holds both the assessment response data as well as key pieces of information about the assessor. These additional pieces of information are beneficial for analyzing the data as a whole to derive valuable insights for both individual assessment comparisons as well as marketing trends. Normative database 14 is preferably dynamic, that is, the data stored in normative database 14 changes and is updated as additional assessments are performed. Since the quantity of data in normative database 14 grows as more assessments are conducted, normative database 14 thus allows for the, mining of insights such as industry benchmarks charting the evolution of a marketing organization over time by comparing data of a particular organization against aggregate data of other organizations, or alternatively comparing data to organizations in similar industries, and also by looking at changes for a particular organization over time. Normative database 14 allows for recommendations for what client organizations should do next to improve their marketing capabilities, and thereby achieve measurable improvements to their marketing performance. It facilitates identification of performance gaps between current state (“actual”) versus desired state (“expected” or “targeted”) performance. Through the mapping of specific marketing capability attributes to the business challenges that organizations routinely face, the model provides sales professionals, consultants and account/product managers with tools assist in understanding the root causes of the variance(s).

Once root causes of performance variances are known, it is preferable to not simply suggest that an organization improve the data it uses in marketing, or that it improve match rate; to be more useful, the solution may, for example, differentiate one good and appropriate investment in capability creation from another perhaps equally good investment, model the economic value of specific recommended investments, and illustrate the logical progression of capability investments that are needed. For example, certain “foundational” capabilities may be needed before those capabilities may be optimized. Thus more value can be provided to the marketing organization by a tool that can optimize the economic value by sequencing investments in a prescribed order; estimate and measure marketing results from implementing the recommendations and the sequencing; and compare investment cost and risk to expected gains on, for example, a quarter-by-quarter basis, in order to set realistic improvement goals and targets. The use of normative database 14 allows organizations to compare results to other similar organizations within and across industries.

Information used to construct normative database 14 may include, at the highest level, at least two types of data: assessment scores (current and target) by organizations for individual marketing capabilities-dimensions-attributes, and organizational information, such as industry, location, geography, business description, economic performance, and performance metrics. Using normative database 14, CMM processor 10 may generate detailed assessment reports 20 through output processor 18, including, for example, those showing comparisons to benchmarks, best practices, norms and trends across time; deviation reports that identify areas of greatest differences between an individual company's results and those of the company's industry peers, best practices, and benchmark capabilities, and specific opportunities for improvement; cause and effect reports that identify the factors that drive assessment results, allowing clients and other users to focus on actionable areas; assessment analysis reports that identify client or prospect strengths and opportunities for improvement, ranked by degree of difficulty and expected return on investment (ROI); and “Prescribed Next Best Actions” reports, which identify the improvement initiatives that are prescribed to improve the organization's marketing effectiveness, along with expected improvements in relevant key performance indicators if an organization were to implement the prescribed next best action and expected improvements in relevant economic performance if an organization were to implement the prescribed next best action.

A goal of certain embodiments is the identification of shortcomings—or “gaps”—in an organization's marketing capability maturity. A “gap” is defined as the mathematical difference between the current state and target state capability maturity scores. Current state is preferably determined with objective, observable evidence, and is characterized by inter-coder reliability, meaning that if two or more independent coders follow the maturity assessment methodology, each will arrive at the same score assuming they inspect the same evidence. Inter-coder reliability is achieved in part by the use of binary (e.g., “yes” or “no”) questions during the assessment. The questions are preferably written with evidence supplied so that there is no mistaking the operational intention, and thus there is no room for interpretation (or misinterpretation) of the intent. In alternative embodiments, inter-coder reliability could be achieved by the use of multiple questions that ask the same question differently in order to confirm the accuracy of results. Target state is determined via discussion with organization leaders, and is understood to represent the capability maturity that is required for the organization to achieve its stated business objectives.

In certain embodiments, each attribute is analyzed by means of CMM processor 10 according to six possible levels. Those levels are level 0 “not performed,” level 1 “performed,” level 2 “managed,” level 3 “standards,” level 4 “quantifiable,” and level 5 “optimized.” As explained further below, an “n/a” score is also possible for each attribute. Each level indicates a stage of maturity with respect to this particular attribute. The maturity assessment methodology guides organizations through a series of “Yes” or “No” assessment interview questions, facilitating the creation of both current and target capability scores. The assessment interview questions are progressive—the answer to the first question governs the progression to the next question, and to each following question. Questions are asked in order, beginning with Level 1, then advancing to the next higher level until a “No” answer is reached. Assessments conducted through CMM processor 10 may include actual observation of operations, collection and review of organization reports, including business dashboard reports, business plans, budgets, procedure documents, policy documents, employee training courses, and documentation for existing processes and systems as required. The question with the highest “Yes” answer is recorded as the current score. By following this method, current capability maturity is scored for each attribute.

Target state is determined via discussion with company leaders and input through CMM processor 10, and is understood to represent the capability maturity that is believed to be required for the company to achieve its stated business objectives. To determine the target capability maturity score, the same process of asking binary, “Yes” or “No” questions is followed. The question with the highest “Yes” answer for target capability is recorded as the target score. By following this method, target capability maturity is determined for all attributes. It should be noted that in certain embodiments, the target state cannot be set lower than the current state for any attribute.

Individual organizations have unique planning cycles, and at any point in time may be in a different planning stage. In certain embodiments the present invention accommodates this by providing that target capability maturity levels may be established for a one-, two-, or three-year time horizon. Other time periods are possible in alternative embodiments.

The various questions may be used in interviews with members of the organizations conducted through CMM processor 10. Such interviews may include direct, one-on-one interviews with key personnel, account executive planning sessions, and partner, broker, or reseller assessments of the organization, with data entered through CMM processor 10 in order to facilitate further processing.

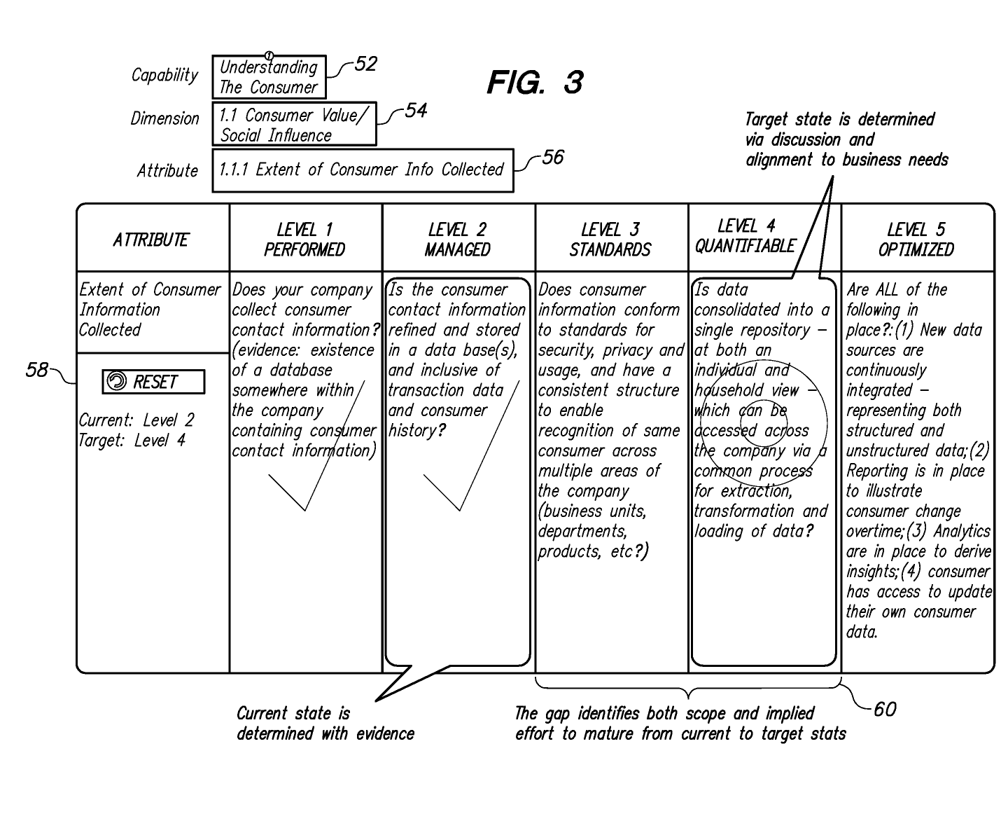

Referring now specifically to the example illustrated in FIG. 3, a particular capability 52, dimension 54, and attribute 56 are being examined as part of an interview process for assessing an organization. In this case, capability 52 is “Understanding the Consumer,” the dimension 54 within that capability 52 is “1.1 Consumer Value/Social Influence,” and the attribute 56 within that dimension is “1.1.1 Extent of Consumer Information Collected.” Questions list 58 is presented for purposes of scoring this attribute, such questions being stored in the data structure of BOK 12 in maturity attribute record 38 shown in FIG. 2C, and accessed for processing by CMM processor 10. In this example of FIG. 3, the current state is “Level 2 Managed,” since the last “yes” answer in questions list 58 was “Is the consumer contact information refined and stored in a data base(s) and inclusive of transaction data and consumer history?” The identified target state is “Level 4 Quantifiable,” determined as described above. The gap 60, which in this case has a numeric value of 2, represents the level difference between the target state and current state with respect to this attribute 56.

In certain embodiments, in addition to receiving a score in response to the questions in question list 58, another possible answer is simply “n/a.” This answer represents the “not assessing” or “not applicable” case where the organization is not attempting to address a particular capability, dimension, or attribute. Although “n/a” is used in certain embodiments, the “not assessing” case can be represented by any other alphabetic or numeric character or characters. There is no gap in the case of an “n/a” score; since the organization has not attempted to achieve this capability, dimension, or attribute, then identifying a positive gap would not be meaningful. On the other hand, the gap score cannot be considered to have a zero value in certain embodiments, since that would indicate a capability, dimension, or attribute target value that was fully met.

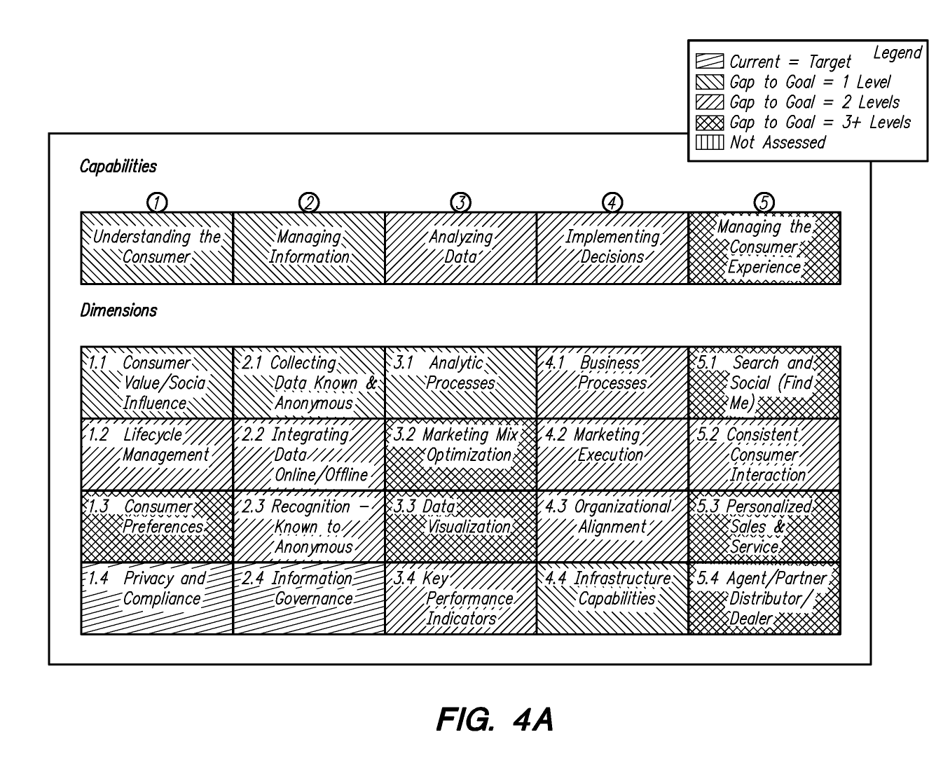

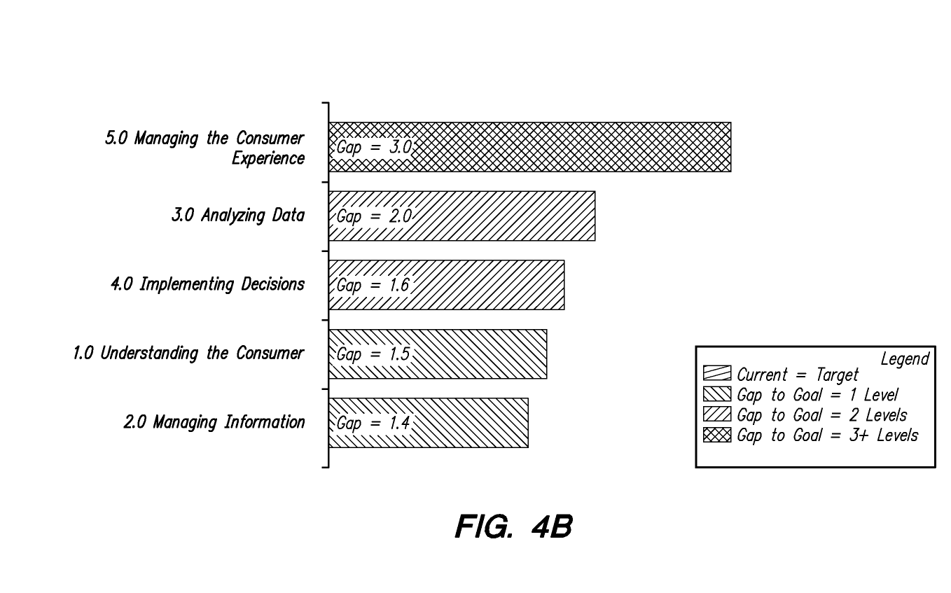

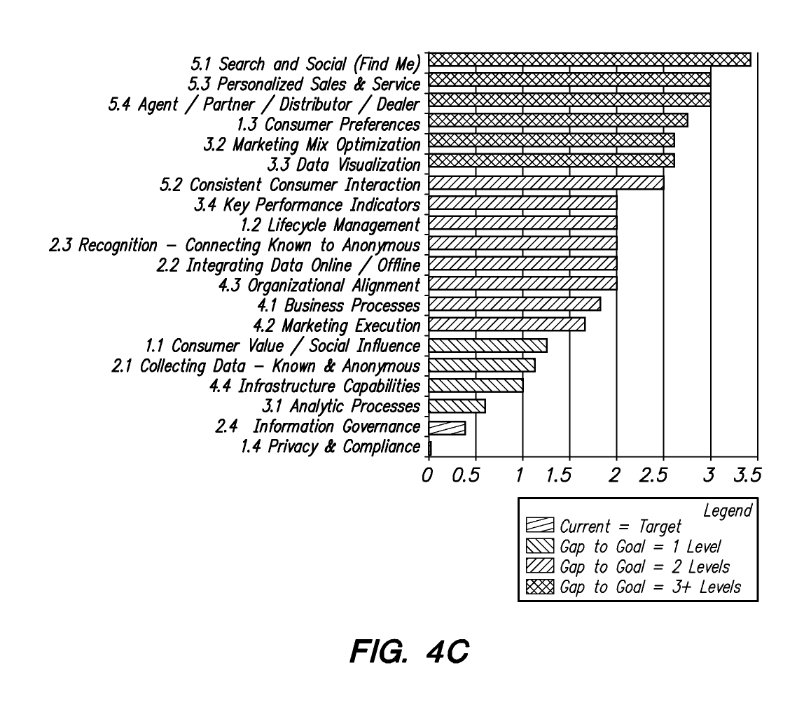

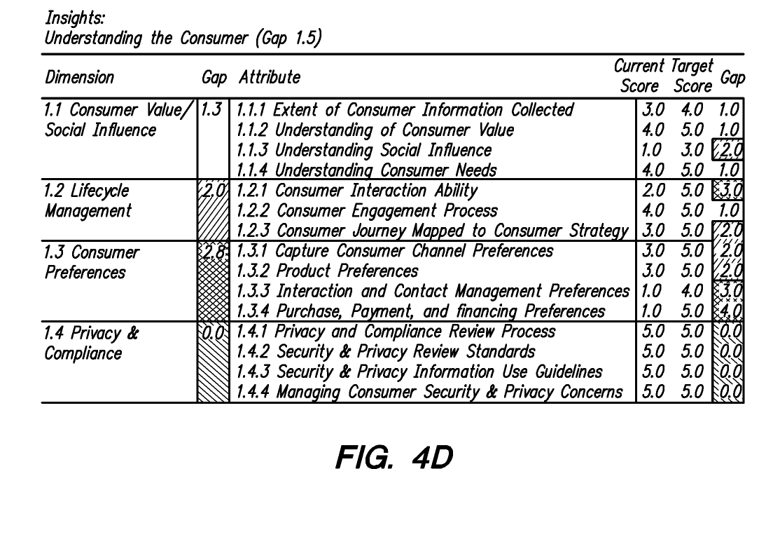

Turning now to FIGS. 4A through 4D, management output variations of reports 20 that may be created through CMM processor 10 according to certain embodiments of the present invention may now be described. The exemplary assessment “heat map” illustrated in FIG. 4A provides a visual report of capability gaps. Gaps are determined by subtracting current level score from target level score, as noted above. A color such as red may be used to visually indicate where large gaps exist, orange and yellow indicates lesser gaps, with green representing areas where an organization is currently performing at or near its target level. (Shading is used to represent various colors in FIGS. 4A through 4F.) The assessment “heat map” of FIG. 4A gives a high-level perspective of a company's relative gaps, and an indication of where change is most urgently needed to meet stated business targets.

FIG. 4B illustrates an example of a capabilities sorted by gap report. Again, gaps are determined by subtracting current level score from target level score, and different colors may be used to indicate the size of gaps in particular areas. This approach provides the organization with a high-level perspective of its relative gaps, and an indication of where change is most urgently needed to meet stated business targets.

FIG. 4C illustrates an example of a dimensions sorted by gap report. The gaps are shown on the dimension level rather than the capability level as in FIG. 4B. Again, the dimensions are preferably sorted by gap in order that the organization may quickly and easily visualize its largest gaps, thus providing an indication of where change is most urgently needed to meet stated business targets.

FIG. 4D illustrates an example of the consumer report for the first capability, “Understanding the Consumer,” according to certain embodiments. In this report, gaps are summarized by dimension, and then broken out row-by-row for each attribute. Again, color may be used to help the organization easily visualize the size of the gaps being shown. The capability gap is presented at the top of the report.

CMM processor 10 may be used to calculate capability and dimension scores from attribute scores by “rolling up” the values from attributes to the associated dimensions, and then from dimensions to the associated capability and business challenge. An overall score can then be calculated by rolling up the capability scores into a single score. In this process, the score for a particular dimension may be calculated by taking the underlying attribute current scores and averaging them. For example, if there are six attributes associated with a dimension with the scores 4, 4, 2, 2, 1, and 1, then the current dimension score would be 2.3. As noted above, in certain embodiments there may be attributes that were scored “n/a.” The “n/a” scores are not considered in calculating the average. In order for a dimension to receive a current score, however, in certain of these embodiments 60% of the underlying attributes must have a current score of 0-5 (i.e., other than “n/a”) for the dimension to have a 0-5 score; otherwise, that dimension receives an overall score of “n/a.” So in the foregoing example, since 60% of the underlying attributes would be 3.6 attributes (6 multiplied by 60%), this means that at least 4 attributes must have received a score other than “n/a” for this dimension to receive a 0-5 score. Stated differently, no more than 2 attributes could have been scored “n/a” in order for the dimension to receive a 0-5 score. In a similar manner capability scores may be calculated from the associated dimension scores, and an overall score calculated for the organization from the rolled-up capability scores.

A capability maturity model quotient (“MMQ”) may be calculated based upon the results of the processing performed by CMM processor 10 to calculate overall, capability, dimension, and attribute MMQs. The calculation of an MMQ facilitates the understanding by an organization's principles of how the organization fares either overall (an overall MMQ) or MMQs that are calculated for particular capabilities, dimensions, or attributes. The use of MMQs also allows for simple benchmarking of an organization's capabilities against other organizations overall or, for example, organizations in the same industry, geography, or across time. For each score, an MMQ may be calculated in certain embodiments by dividing the score by the maximum possible score, and then normalizing to a desired range, such as 0-100. In the example given above with six attribute scores of 4, 4, 2, 2, 1, and 1, the maximum possible score would be 30, and the normalized MMQ for that dimension would be 47. MMQs may be rolled up from the dimension level to the capability and the overall level in a manner similar to that described above with respect to raw scores.

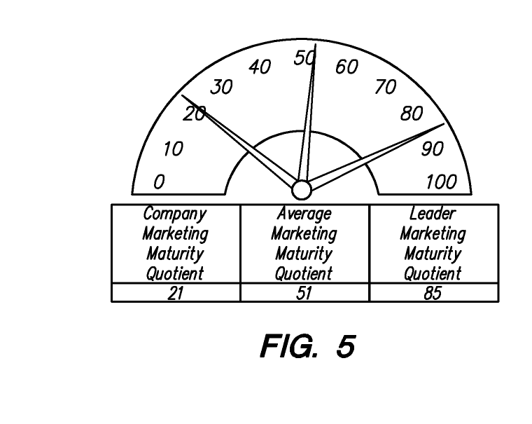

FIG. 5 illustrates another output as part of reports 20 generated by CMM processor 10 that illustrates a “marketing maturity meter” displaying the overall capability MMQ for an organization in comparison to average and leader MMQs. The average is calculated by averaging the MMQ for all organizations in the related industry for which data has been collected through assessments and stored in normative database 14. For the particular attribute shown in this example, it may be seen that the overall MMQ for the company measured (as reported on a 0-100 scale in certain embodiments) is 21. This may be easily visualized in comparison to the average MMQ on this attribute of 51, and the leader's MMQ on this attribute of 85. In this example, the organization is easily visualized as lagging both the average for overall marketing capability and the leaders, which in certain embodiments may be the average of the top ten percent of organizations as reflected in the data maintained dynamically in normative database 14.

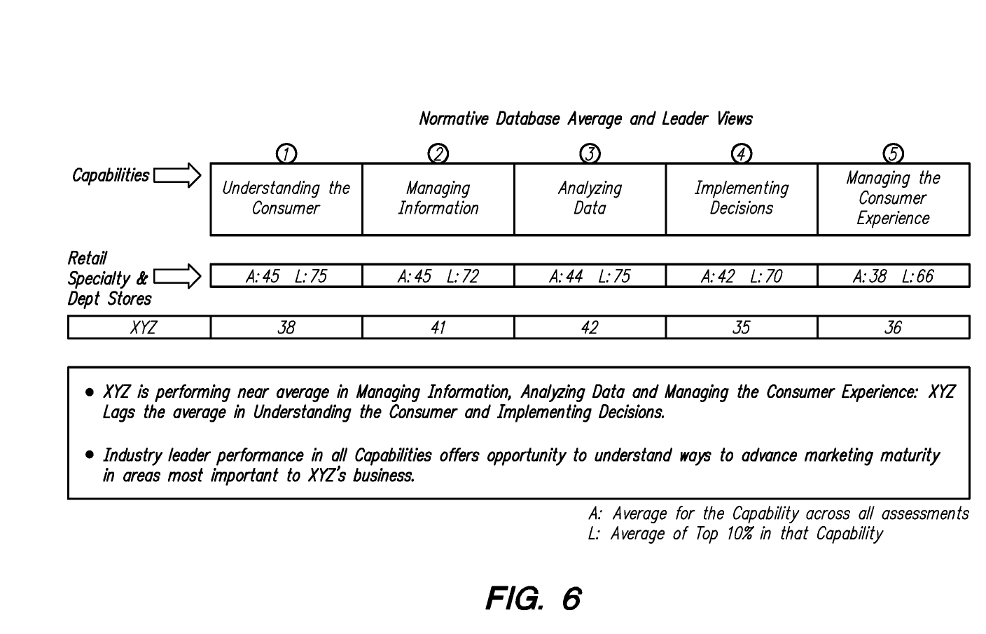

FIG. 6 illustrates an example table as part of reports 20 generated by CMM processor 10 that shows the individual capability MMQ scores for an organization compared to benchmark averages and leaders. The MMQ table in this example provides a visual report of capability MMQ scores compared to the Retail Specialty and Dept. Stores average and leaders. Additional text may be included, as illustrated, further explaining the status of the organization among its peers. In this case, “A” is used to designate the average for this industry group and “L” designates the top ten percent of MMQs in that capability.

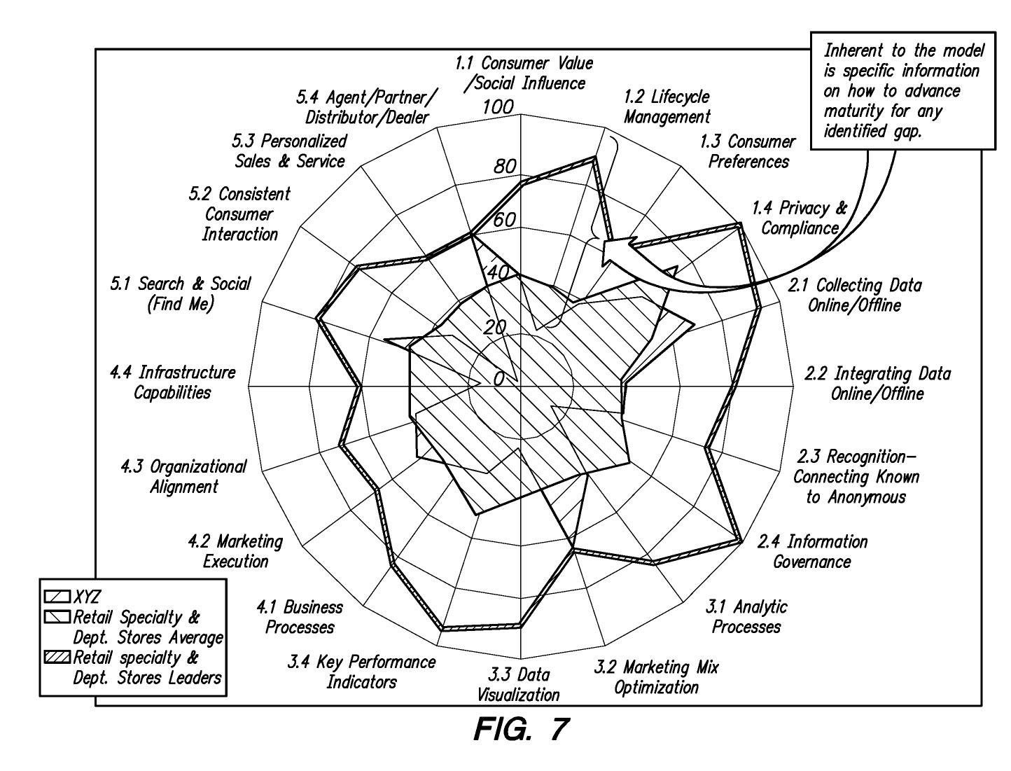

FIG. 7 illustrates an example of a “spider chart” for the assessed MMQ dimensional scores compared to benchmark (i.e. industry, sub industry, geographical, financial) averages and leaders, which again may be a part of reports 20 generated through output processor 18 by CMM processor 10. The spider chart of this example has three overlays. The first shows the MMQ dimensional scores for all dimensions for the company taking the assessment. The second overlay shows the dimensional MMQ scores for the “benchmark” average, based on data from normative database 14. The third overlay depicted by the outer line on the graph depicts the dimensional MMQ scores for the benchmark leaders (again in this example, the top 10% of the benchmark assessments). This spider chart gives a comparative look of a company's relative current state to benchmark average and leaders and provides immediate visual insight to where a company is lagging or leading best practices. The various benchmarks applied could be, in various examples, by industry (i.e., Financial Services, Retail); by sub-industry (i.e., Retail Banking, Non-Consumer Apparel); geographical (i.e., Asia-Pacific, Latin America, North America, Europe-Middle East-Africa); or financial (i.e., Sales>$5 billion, Sales<$5 billion).

Once scoring for an organization is complete at CMM processor 10, in certain embodiments further processing may include the suggestion of various products and services targeted at addressing gaps or areas where the organization is found to lag averages or leaders. Product catalog 16, as illustrated in FIG. 1, may be used as a database that provides matching information for products and services that correspond to particular capabilities, dimensions within capabilities, or attributes within dimensions. The result of this matching by CMM processor 10 is further reports, within reports 20, that suggest further actions or next steps by the organization for improvement.

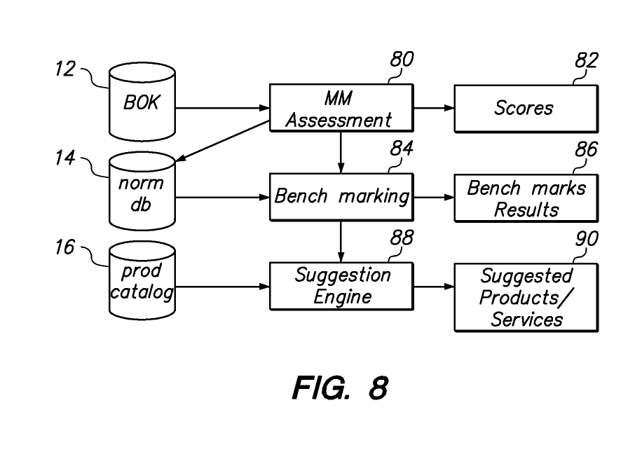

In one example of processing utilizing the foregoing, the flow diagram of FIG. 8 shows steps in the processing performed by CMM processor 10. At a first stage, MM assessment 80, information from BOK 12 is used to formulate the appropriate questions in order to collect data necessary for scoring. The result of this process is a set of scores 82, which may include raw scores and/or MMQs. In certain embodiments, MM assessment 80 also writes scores 82 to normative database 14, in order that normative database 14 is strengthened by the dynamic addition of information for this particular organization. In this way, the quality of normative database 14 improves as additional organizations are assessed, since the available aggregate data for benchmarking will thus increase. At the second stage, benchmarking 84, the scores 82 previously generated are compared with data from other organizations in normative database 14 in order to create benchmark results 86. At a third stage, suggestion engine 88, scores 82 and optionally benchmark results 86 are used to compare with product catalog 16 in order to create as an output suggested products or services 90. It may be seen that the ultimate result of the process performed by CMM processor 10 and the related components of certain embodiments as described is information allowing an organization to judge its marketing maturity, compare that maturity to other organizations, and a roadmap allowing the organization to determine how best to proceed in order to improve its maturity either overall, or at the capability, dimension, or attribute level.

In addition to using attributes, particular business challenges from BOK 10 may be mapped to attributes and used in the assessment described herein, as well as in analytics after assessment is complete. In certain embodiments, the invention may further employ “customized” assessments in which the organization itself supplies its own particular business challenges based on its experience, and those are mapped to a particular attribute or attributes as stored in BOK 10.

It may be seen that normative database 14, as described above, contains a dynamic data structure that improves as more assessments are performed. Once a normative database 14 is constructed in this manner, however, it may be applied to other applications than those strictly involved in capability assessment for marketing organizations. For example, normative database 14 may be used for data mining by a marketing services provider. In one example, the marketing services provider may determine from an analysis of the data in normative database 14 where organizations in a particular industry tend to have gaps or larger gaps, and then use this information to develop a product or service particularly tailored to addressing this gap. The product or service may then be added to product catalog 16.

CMM processor 10 and output processor 18 may each be implemented in hardware as a computing device, which is programmed by means of instructions to result in a special-purpose computing device to perform the various functionality described herein. The computing device may be implemented in a number of different forms. For example, it may be implemented as a standard computer server, or as a group of such servers. The computing device may also be implemented as part of a rack server system, as are well known in the art. In addition, it may be implemented in a personal computer such as a desktop computer or a laptop computer.

CMM processor 10 may include a microprocessor or microprocessors, which may operate either in serial or parallel processing modes, a memory, an input/output device such as a display and keyboard, and a storage device, such as a solid-state drive or magnetic hard drive. These components are interconnected, such as by bus, and may be mounted on a common PC board or separate PC boards. The microprocessor or microprocessors are operable to execute instructions read into the memory from the storage device. The memory may be implemented as one or more of a computer-readable medium or media, a volatile memory unit or units such as flash memory or random-access memory (RAM), or a non-volatile memory unit or units such as read-only memory (ROM). The memory may be partially or wholly integrated within the microprocessor. Various implementations of the various embodiments of the invention may be implemented in hardware, firmware, software, or any combination thereof. The invention in various embodiments may be implemented as a computer program product stored on a non-transitory tangible computer-readable medium in communication with a microprocessor or microprocessors, wherein the computer program product comprises instructions that may be loaded into the memory and executed at the microprocessor or microprocessors to achieve the functions described herein.

In conjunction with CMM processor 10 may be a client device, which may be implemented in various ways according to certain embodiments, including a desktop personal computer, a laptop personal computer, a tablet, a smartphone, or a terminal. CMM processor 10 may communicate with the client device through any of various types of networks, including the Internet. Questions generated in the process of assessing marketing maturity may be sent from CMM processor 10 for display at the client device, and answers in response to those questions may be sent back to CMM processor 10 through inputs at the client device. The various reports 20 may be sent to the client device for display to an end user. In addition, the client device may receive scores 82, benchmark results 86, and suggested products/services 90 for display to an end user.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a Markush group or other grouping is used herein, all individual members of the group and all combinations and subcombinations possible of the group are intended to be individually included. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

1. A computer-implemented method for analyzing the marketing capability of an organization, comprising the steps of:
a. sending from a capability maturity model (CMM) processor a next binary question from an ordered set of binary questions associated with a marketing capability attribute, wherein the ordered set of binary questions is stored in a body of knowledge (BOK) in communication with the CMM processor;
b. receiving at the CMM processor an answer to the next binary question, wherein the answer to the next binary question is “yes” or “no”;
c. repeating steps (a) and (b) until the answer to the next binary question received at the CMM processor is “no”;
d. determining at the CMM processor a current attribute level for the marketing capability attribute, wherein the current attribute level corresponds to a last “yes” answer; and
e. writing from the CMM processor the current attribute level into a normalized database in communication with the CMM processor.

2. The computer-implemented method of claim 1, further comprising the steps of:
a. receiving at the CMM processor a target attribute level for the marketing capability attribute associated with a timeframe;
b. calculating at the CMM processor a gap for the marketing capability attribute by subtracting the current attribute level from the target attribute level; and
c. writing from the CMM processor the target attribute level and the gap for the marketing capability attribute into the normalized database.

3. The computer-implemented method of claim 2, wherein the question possesses inter-coder reliability.

4. The computer-implemented method of claim 2, wherein the BOK comprises a plurality of attributes each associated with one of a plurality of dimensions.

5. The computer-implemented method of claim 4, wherein the BOK comprises a plurality of dimensions each associated with one of a plurality of capabilities.

6. The computer-implemented method of claim 5, further comprising the step of calculating at the CMM processor a dimension marketing maturity quotient (MMQ) for each of the plurality of dimensions.

7. The computer-implemented method of claim 6, wherein the step of calculating at the CMM processor a dimension MMQ for each of the plurality of dimensions comprises the steps of summing each of the current attribute levels for the marketing capability attributes associated with each of the plurality of dimensions to create a current attribute level sum, dividing the current attribute level sum by a maximum value for the current attribute levels for the marketing capability attributes associated with each of the plurality of dimensions to produce an aggregate dimension value, and normalizing the aggregate dimension value.

8. The computer implemented method of claim 7, further comprising the step of calculating at the CMM processor a capability MMQ for each of the plurality of capabilities.

9. The computer-implemented method of claim 8, further comprising the step of calculating an overall MMQ for the organization.

10. The computer-implemented method of claim 9, further comprising the steps of:
a. accessing from the CMM processor the normative database to retrieve one or more of an average MMQ and a leader MMQ; and
b. displaying a comparison between the MMQ and one or more of the average MMQ and the leader MMQ.

11. The computer-implemented method of claim 10, further comprising the step of utilizing the overall MMQ to generate a set of suggested products/services from a product catalog in communication with the CMM processor.

12. The computer-implemented method of claim 6, wherein the answer may comprise a not applicable value and wherein the step of calculating at the CMM processor a dimension MMQ for each of the plurality of dimensions comprises the step of generating the not applicable value for each of the plurality of dimensions for which more than a minimum percentage of the current marketing capability attribute levels for that dimension have the not applicable value.

13. The computer-implemented method of claim 12, wherein the minimum percentage of the current marketing capability attribute levels for that dimension that have the not applicable value is sixty percent.

14. The computer-implemented method of claim 1, wherein the BOK comprises a plurality of business challenges each associated with at least one of the marketing capability attributes, and further comprising the step of calculating at the CMM processor a marketing maturity quotient (MMQ) for at least one of the business challenges.

15. A computer program product for analyzing the capability of a marketing organization, the computer program product being stored on a non-transitory tangible computer-readable medium in communication with a processor and comprising instructions that, when executed at the processor, cause a computer system to:
a. transmit from the processor a first question from a set of questions related to an marketing capability attribute, wherein the set of questions is stored in a body of knowledge (BOK) in communication with the processor;
b. receive at the processor an answer to the first question of the set of questions, wherein the answer is one of a “yes” response and a “no” response;
c. if a “yes” response is received at the processor in answer to the first question, transmit from the processor a second question from the set of questions related to the marketing capability attribute, but if a “no” response is received at the processor in answer to the first question, not transmit from the processor a second question from the set of questions related to the marketing capability attribute;
d. calculate at the processor a current attribute level by associating a level with a last “yes” response received at the processor;
e. receive at the processor a target attribute level associated with the marketing capability attribute;
f. calculate at the processor a gap associated with the marketing capability attribute by subtracting the target attribute level from the current attribute level;
g. send a display message to a client device from the processor, wherein the display message comprises a graphic visualization of the gap associated with the marketing capability attribute; and
h. store the current attribute level, the target attribute level, and the gap in a normative database in communication with the processor.

16. The computer program product of claim 15, further comprising instructions that, when executed at the processor, cause a computer system to receive at the processor a target timeframe associated with the target attribute level and store the target timeframe in the normative database.

17. The computer program product of claim 16, further comprising instructions that, when executed at the processor, cause a computer system to calculate a marketing maturity quotient (MMQ).

18. The computer program product of claim 17, further comprising instructions that, when executed at the processor, cause a computer system to:
a. access the normative database to retrieve one or more of an average MMQ and a leader MMQ;
b. display a comparison between the MMQ for the marketing capability attribute and one or more of the average MMQ and the leader MMQ.

19. The computer program product of claim 18, further comprising instructions that, when executed at the processor, cause a computer system to calculate an average MMQ by summing a plurality of organization MMQs stored in the normative database and dividing by a total number of organization MMQs.

20. The computer program product of claim 19, further comprising instructions that, when executed at the processor, cause a computer system to calculate a leader MMQ by identifying a leader subset of a plurality of organization MMQs, summing the subset of organization MMQs stored in the normative database and dividing by a total number of the subset of organization MMQs.

21. The computer program product of claim 18, wherein the BOK comprises a plurality of marketing capability attributes each associated with one of a plurality of dimensions, and further wherein the BOK comprises a plurality of dimensions associated with one of a plurality of capabilities.

22. The computer program product of claim 16, further comprising instructions that, when executed at the processor, cause a computer system to access a product catalog comprises a plurality of suggested products or services each mapped to the current attribute level, the target attribute level, and the target timeframe, and return at least one of the plurality of suggested products or services correlated to the current attribute level, the target attribute level, and the target timeframe.

23. A computerized marketing capability system, comprising:
a. a body of knowledge (BOK) comprising a plurality of marketing capability attributes and, for each marketing capability attribute, further comprising a plurality of marketing maturity questions;
b. a normative database, the normative database comprising, for each of a plurality of organizations, a plurality of answers matched to the plurality of marketing questions; and
c. a capability maturity model (CMM) processor programmed by computer software accessible in a memory in communication with the CMM processor, the CMM processor being in communication across a network with the BOK and the normative database, the computer software comprising algorithms to calculate a marketing capability attribute gap for each marketing capability attribute of one of the plurality of marketing organizations by subtracting a target level for each marketing capability attribute from a current level for each marketing capability attribute, and store the marketing capability attribute gap in the normative database.

24. The computerized marketing maturity system of claim 23 further comprising a campaign processor in communication with the CMM processor, wherein the campaign processor comprises marketing campaign information for the one of the plurality of marketing organizations.

25. The computerized marketing maturity system of claim 24, further comprising a product catalog in communication with the CMM processor, wherein the product catalog comprises a matching between each of the plurality of marketing capability attributes and one or more product or service applicable to improvement of such one of the plurality of marketing capability attributes.

26. The computerized marketing system of claim 23, wherein the computer software further comprises algorithms to update the normative database with current marketing capability attributes pertaining to each of the marketing organizations.

27. The computer marketing system of claim 23, wherein the computer software further comprises algorithms to calculate at least one organization marketing maturity quotient (MMQ) for at least one of the plurality of marketing organizations.

28. The computer marketing system of claim 27, wherein the computer software further comprises algorithms to calculate one or more of an average MMQ and a leader MMQ, retrieve from the normative database one or more of the average MMQ and the leader MMQ, and compare the organization MMQ with one or more of the average MMQ and the leader MMQ.

29. A computer system for assessing marketing capability, comprising:
a. a body of knowledge (BOK) comprising a plurality of binary question sets, each binary question set corresponding to an organization attribute;
b. a normative database comprising, for each of a plurality of organizations, a set of organization attribute values for each of the organization attributes, a marketing maturity quotient (MMQ) for each of the plurality of organizations, and an average MMQ for the plurality of organizations; and
c. a processor configured to dynamically receive a subsequent set of organization attribute values, calculate an MMQ for the subsequent set of organization values, and update the average MMQ for the plurality of organizations based on the subsequent set of organization attribute values.

30. The computer system of claim 29, wherein the normative database further comprises a leader average MMQ for the plurality of organizations within the industry, and wherein the processor is further configured to update the leader average MMQ for the plurality of organizations in response to receiving a subsequent set of organization attribute values.
